(19) United States
(12) Patent Application Publication
(10) Pub. No.: US 2012/0168418 A1
(43) Pub. Date: Jul. 5, 2012

(54) HEAT CONTROL DEVICE OF HEAT GENERATING GLASS

(76) Inventors: Dong Il Lee, Gyeongi-do (KR); Beom Goo Son, Gyeonggi-do (KR); Il Joon Bae, Daejeon (KR)

(21) Appl. No.: 13/394,778

(22) PCT Filed: Sep. 16, 2010
(86) PCT No.: PCT/KR10/06350

§ 371 Date: Mar. 7, 2012

(30) Foreign Application Priority Data
Sep. 24, 2009 (KR) 10-2009-0090511

(51) Int. Cl. H05B 1/00

(52) U.S. Cl. 219/209; 219/482; 219/494

(57) ABSTRACT

Provided is a heat control device of a heat generating glass, which supplies a sine wave signal for controlling temperature of the heat generating glass according to a size of the heat generating glass, so that the sine wave signal is input at a point of time when the current of the sine wave signal is zero and also the supply of the sine wave signal is stopped at the point of time when the current of the sine wave signal is zero. Herein, the sine wave signal is supplied to the heat generating glass so as to control the power supply considering to the load of the heat generating glass, and a zero point of the sine wave signal is detected using a phase detection part, and a heat control part generates a control signal so that the sine wave signal is input at a point of time when the current of the sine wave signal is zero and also the supply of the sine wave signal is stopped at the point of time when the current of the sine wave signal is zero, and then transfers the control signal to a driver circuit, and the sine wave signal supplied from a power source part is supplied through the driver circuit to the heat generating glass, and each sine wave signal supplied to each heat generating glass may be supplied with a different supplying period.

### TECHNICAL FIELD

The present invention relates to a heat control device of a heat generating glass, in which an alternating current power (hereinafter, called sine wave signal) is supplied to the heat generating glass so as to control heating temperature thereof by controlling the power supply considering to the load of the heat generating glass, and a zero point of the sine wave signal is detected using a phase detection part comprised of a photocoupler and the like, and a heat control part is provided so as to control a point of time when the sine wave signal is supplied or stopped using the zero point detected from the phase detection part, and the heat control part generates a control signal so that the sine wave signal is input at a point of time when the current of the sine wave signal is zero and also the supply of the sine wave signal is stopped at the point of time when the current of the sine wave signal is zero, and then transfers the control signal to a driver circuit, and the driver circuit is constructed so that the sine wave signal is output to the heat generating glass during a time period designated by the control signal, and the number of sine wave signals are differently supplied so as to control the plurality of heat generating glasses having different load from each other.

### BACKGROUND ART

In a conventional heat generating glass, heat generation was generally controlled by AC phase control using a heat control device for controlling a heating temperature, thereby preventing dew condensation on a surface of the heat generating glass. However, as shown in FIG. 1, since electric power supplied to the heat generating glass is cut off while the current is flowed, a peak current is generated at the cut-off position. Therefore, there are some problems that noise is generated seriously, life span of electronic devices employed in a power control unit becomes short, and current load increases.

### DISCLOSURE OF INVENTION

An object of the present invention is to provide a heat control device of a heat generating glass, which supplies commercial alternating current power (sine wave signal) as power source used in controlling a heating temperature of a heat generating glass so that the power supply is started at a point of time when current of the sine signal is zero and also stopped at the point of time when the current of the sine signal is zero, thereby preventing generation of a peak current when the signal is supplied or stopped, and thus it is possible to reduce the noise generation and increase the life span of the electronic devices, thereby enhancing reliability and durability of the heat control device.

Another object of the present invention is to provide a heat control device of a heat generating glass, in which the supply of the sine wave signal for uniformly or differently controlling electric energy and then supplying it to a plurality of heat generating glasses is started or stopped at the point of time when the current of the sine signal is zero, and the heating temperature of the heat generating glass can be controlled by changing the number of the sine wave signals to be supplied.

Yet another object of the present invention is to provide a heat control device of a heat generating glass, which measures temperature of the heat generating glass and current supplied to each heat generating glass so as to prevent occurrence of overheat or overcurrent, thereby enhancing stability and reliability thereof.

Yet another object of the present invention is to provide a heat control device of a heat generating glass, in which a plurality of control signals and driver circuits are interlocked using a phase detection part and a heat control part so that the sine wave signal is not supplied simultaneously to two or more heat generating glasses, thereby preventing over-load in a power source part.

Yet another object of the present invention is to provide a heat control device of a heat generating glass, which measures indoor temperature and humidity, finds a temperature that the dew condensation does not occur and automatically maintains the temperature, thereby preventing dew condensation on a surface of the heat generating glass.

To achieve the object of the present invention, the present invention provides a heat control device which controls heating temperature of a heat generating glass, comprising a phase detection part which detects a zero point of a sine wave signal; a heat control part which generates a control signal for controlling supply of the sine wave signal using the zero point of the sine wave signal detected by the phase detection part, so that the sine wave is input to the heat generating glass at a point of time when current of the sine wave signal is zero and also the supplying of the sine wave signal is also stopped at the point of time when the current of the sine wave signal is zero; and a driver circuit which supplies the sine wave signal to the heat generating glass at a point of time designated by the control signal using the control signal transferred from the heat control part and the sine wave signal input from a power source part.

Preferably, the heat control part supplies the plurality of control signals to the plurality of driver circuits so as to control the heating temperature of the plurality of heat generating glasses.

Preferably, the heat control part controls the sine wave signal so that the sine wave signal is input at a point of time when the current of the sine wave signal is zero, and also the supply of the sine wave signal is stopped at the point of time when the current of the sine wave signal is zero, and when the sine wave signal is supplied to the plurality of the heat generating glasses, the control signals different from each other are supplied to the plurality of driver circuits so that the sine wave signal is not supplied simultaneously to two or more heat generating glasses, thereby preventing an increase of load in the power source part.

Preferably, the heat control part comprises a temperature detection part for detecting temperature of each heat generating glass, and a current detection part for measuring current supplied to each heat generating glass, and also the heat control part stops the power supply when overheat or overcurrent is generated.

Preferably, the phase detection part is comprised of a photocoupler.

Preferably, the heat control part supplies the sine wave signal so as to measure indoor temperature and humidity using a temperature and humidity sensor, find a temperature of the heat generating glass that dew condensation does not occur, based on the measured temperature and humidity, and automatically maintain the temperature that the dew condensation does not occur, thereby preventing occurrence of the dew condensation.

Preferably, the heat control part comprises an input and operation part which inputs a setting temperature of the heat generating glass and operates the heat control device, and further comprises a display part which displays the setting temperature and present temperature.

Preferably, the heat control device further comprises a communication part for receiving/transferring a signal from/to an external device.

### BRIEF DESCRIPTION OF DRAWINGS

FIG. 1 is a view showing signal supplied to a conventional heat generating glass.

FIG. 2 is a schematic view of a heat control device of a heat generating glass according to the present invention.

FIGS. 3 to 5 views of the heat control device of the heat generating glass according to various embodiments of the present invention.

FIG. 6 is a view of an example of a phase detection circuit for detecting a zero point from a sine wave signal.

[Detailed Description of Main Elements]

| | |
|---|---|
| 11: alternating current power or commercial | |
| power | |
| 12: power source part | 13: phase detection part |
| 14: communication part | 15: input and operation part |
| 16: display part | |
| 17: temperature and humidity sensor | |

### MODE FOR THE INVENTION

In a heat control device of a heat generating glass of the present invention, a sine wave signal is supplied to the heat generating glass so as to control heating temperature thereof by controlling the power supply considering to the load of the heat generating glass, and a zero point of the sine wave signal is detected using a phase detection part comprised of a photocoupler and the like, and a heat control part is provided so as to control a point of time when the sine wave signal is supplied or stopped using the zero point detected from the phase detection part, and the heat control part generates a control signal so that the sine wave signal is input at a point of time when the current of the sine wave signal is zero and also the supply of the sine wave signal is stopped at the point of time when the current of the sine wave signal is zero, and then transfers the control signal to a driver circuit, and the driver circuit is constructed so that the sine wave signal is output to the heat generating glass during a time period designated by the control signal, and the number of sine wave signals are differently supplied so as to control the plurality of heat generating glasses having different load from each other.

Further, in the heat control device of the heat generating glass of the present invention, the zero point of the commercial alternating current or artificially generated sine wave signal is detected by using a phase detection part 13 manufactured by a photocoupler and the like, and on the basis of the zero point of the sine wave signal, the supply of the sine wave point is started and stopped at the point of time when the current of the sine wave signal is zero, and the plurality of heat generating glasses can be respectively controlled at the same time, and temperature of the heat generating glass and current supplied to the heat generating glass are measured so as to prevent occurrence of overheat or overcurrent, thereby enhancing stability and reliability of the heat control device.

The advantages, features and aspects of the invention will become apparent from the following description of the embodiments with reference to the accompanying drawings, which is set forth hereinafter.

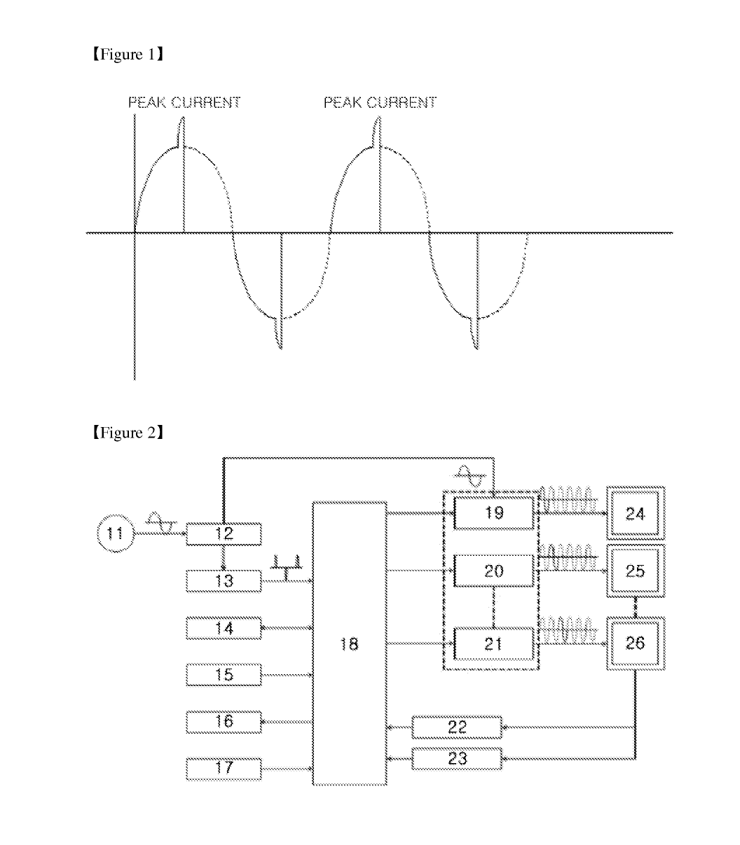

FIG. 1 is a view showing signal supplied to a conventional heat generating glass, FIG. 2 is a schematic view of a heat control device of a heat generating glass according to the present invention, FIGS. 3 to 5 views of the heat control device of the heat generating glass according to various embodiments of the present invention, and FIG. 6 is a view of an example of a phase detection circuit for detecting a zero point from a sine wave signal.

### First Embodiment

The embodiment of the present invention will be described with reference to the drawings. FIG. 2 is a schematic view of a heat control device of a heat generating glass according to the present invention.

In a conventional heat generating glass, the heat generation was generally controlled by AC phase control, thereby controlling a heating temperature of the heat generating glass. However, as shown in FIG. 1, since the signal is cut off while the current is flowed, the peak current is generated at the cut-off position. Therefore, there are some problems that noise is generated seriously, life span of electronic devices employed in a power control unit becomes short.

In the present invention, to solve the problems in the conventional heat generating glass, a zero point of commercial alternating current power or artificially generated sine wave signal is detected by using a phase detection part 13 manufactured by a photocoupler and the like as shown in FIGS. 2 and 6, and a control signal is generated from a heat control part 18 by using the detected zero point of the sine wave signal and then supplied through a plurality of driver circuits 19 to 21 to a plurality of heat generating glasses 24 to 26. Herein, when the control signal is supplied to the plurality of driver circuits 19 to 21, the sine wave signal is input at a point of time when the current of the sine wave signal is zero, and also the supply of the sine wave signal is stopped at the point of time when the current of the sine wave signal is zero, so that a peak current is not generated at the sine wave signal. In such construction as described above, since the peak current is not generated, it is possible to reduce the noise generation and increase the life span of the electronic devices, thereby enhancing reliability and durability of the heat control device.

In the first embodiment, the sine wave signal supplied to the heat generating glass is input at the point of time when the current of the sine wave signal is zero, and the supply of the sine wave signal is stopped at the point of time when the current of the sine wave signal is zero, and thus it is possible to reduce the noise generation and increase the life span of the electronic devices, thereby enhancing reliability and durability of the heat control device. Herein, since the control signal is generated so that the sine wave signal is not supplied simultaneously to two or more heat generating glasses, and then the control signal is supplied through the driver circuit to the heat generating glass at the point of time when the control signal performs the controlling operation, it is possible to stably operate the heat generating glass without an increase of the load in a power source part, and also it is not necessary to increase a capacity of the power source part according to the increase of the load when the sine wave signal is simultaneously supplied to the plurality of heat generating glasses.

Referring to FIG. 2, the plurality of driver circuits 19 to 21 function to supply the sine wave signal to the plurality of heat generating glasses at the same time. Each driver circuit is constructed so that the sine wave signal input from the power source part is controlled by using the control signal input from the heat control part so as to generate the sine wave signal at the zero point and then the generated sine wave signal is supplied to the heat generating glass, and also the power supplying is stopped at the zero point of the sine wave signal.

Referring to FIG. 2, the heat control device of the heat generating glass has the phase detection part 13 manufactured by the photocoupler (referring to FIG. 6) so as to detect the zero point of commercial alternating current power 11 (sine wave signal) or artificially generated sine wave signal. By using the zero point of the sine wave signal, the sine wave signal is supplied to the heat generating glass so that the supplying of the sine wave signal is started at a point of time when current of the sine signal is zero and also the supplying of the sine wave signal is stopped at the point of time when the current of the sine signal is zero. The plurality of control signals generated from the heat control part 18 are input to the plurality of driver circuits so as to control the point of time when the sine wave signal is supplied or stopped. In other words, the control signal controls the point of time when the sine wave signal is supplied or stopped according to a half cycle, one cycle or various cycles of the sine wave signal (360 degrees) on the basis of the zero point detected by the phase detection part 13, and then supplies it to the heat generating glass.

Since the control signal of the sine wave signal, which is supplied to control a temperature of each heat generating glass 24 to 26 using the zero point detected by the phase detection part 13, is formed by a control program, it can be constructed in various ways. That is, in the present invention, on the basis of the zero point of the sine wave signal detected by the phase detection part 13, the sine wave signal is generated at the zero point and then supplied to the heat generating glass, and the supplying of the sine wave signal is also stopped at the zero point of the sine wave signal.

The heat control part 18 of the heat generating glass is provided with a temperature detection part 23 for detecting a temperature of each heat generating glass, and a current detection part 22 for measuring the current supplied to each heat generating glass. Therefore, it is possible to stop the power supplying when overheat or overcurrent occurs, thereby enhancing stability and reliability of the heat generating glass.

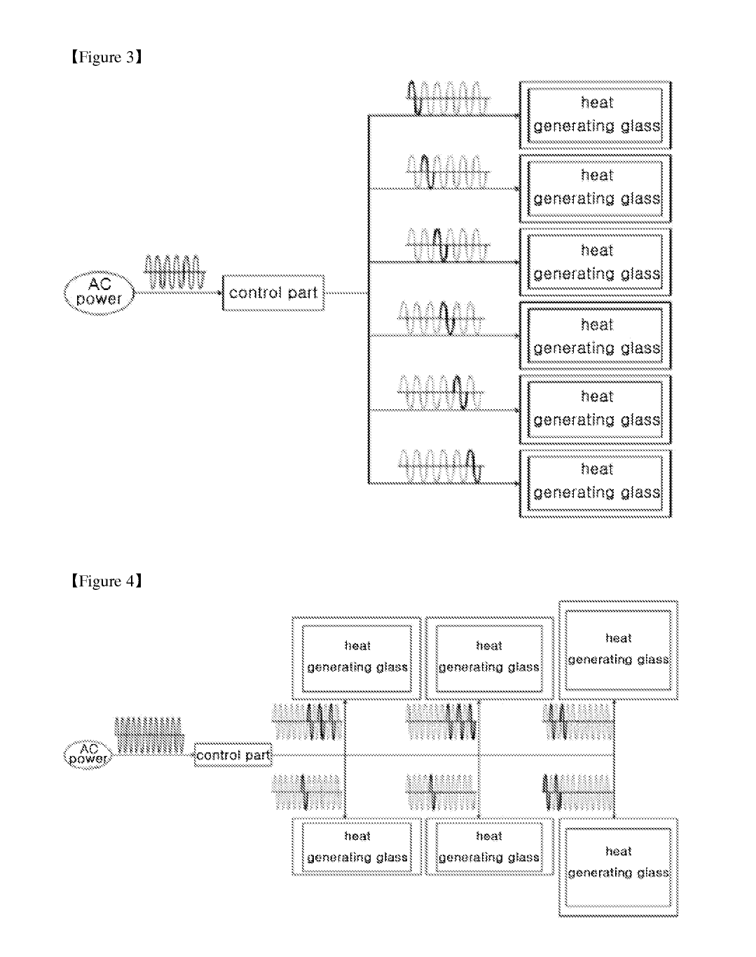

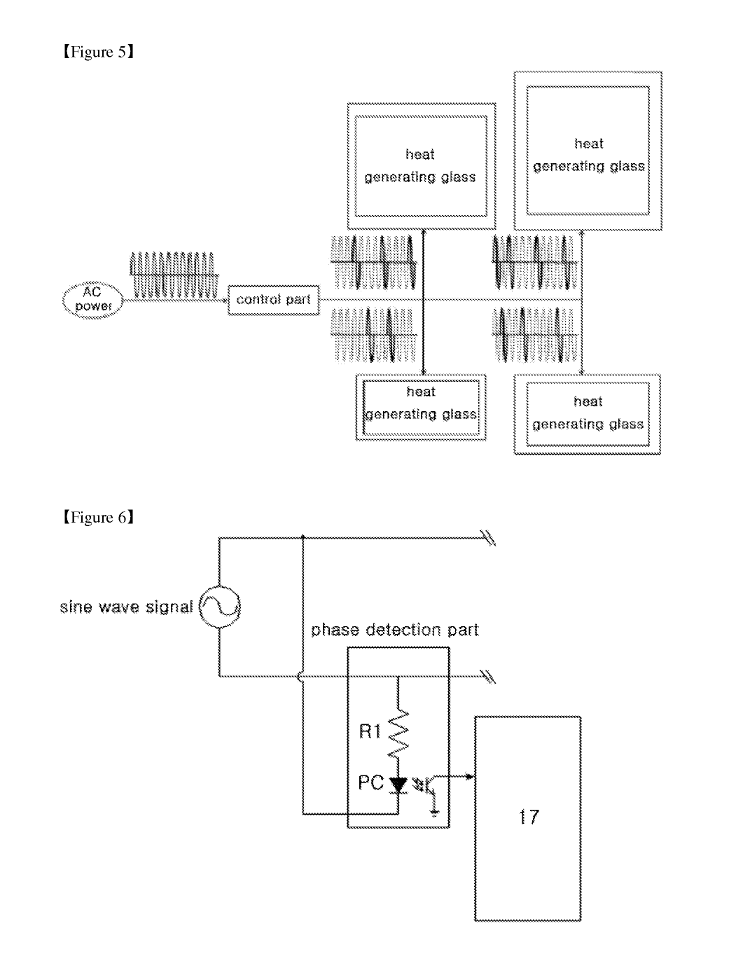

FIGS. 3 to 5 show various embodiments of the heat control device of the heat generating glass according to the present invention. In FIG. 3, the same sine wave signals are supplied through the driver circuit to the plurality of heat generating glasses having the same size (load) at different points in time. In FIGS. 4 and 5, the sine wave signals are supplied to the heat generating glasses having the same or different size (load), and the control signal generated from the heat control part is transferred to the driver circuit so that the sine wave signal supplied to the power source part is supplied at the different points in time according to each load, thereby preventing the increase of the load in the power source part.

When the heat control part 18 of the heat generating glass shown in FIGS. 2 to 5 supplies the sine wave signal to the plurality of the heat generating glasses, the heat control part 18, the power source part 12 and the driver circuits 19 to 21 are interlocked with each other so that the sine wave signal is supplied to each heat generating glass with a time difference, whereby the power supply is performed within a range of the capacity of the power source part.

In FIG. 2, the first sine wave signal is supplied from the driver circuit 19 to the heat generating glass 24, the second sine wave signal is supplied from the driver circuit 20 to the heat generating glass 25, and the third sine wave signal is supplied from the driver circuit 21 to the heat generating glass 26. Herein, since the sine wave signal is controlled to be not supplied simultaneously to two or more heat generating glasses, it is possible to stably operate the heat generating glass without the increase of the load in the power source part and also it is not necessary to increase the capacity of the power source part according to the increase of the load.

### Second Embodiment

The heat control device of the second embodiment is constructed so that the sine wave signal is input at the point of time when the current of the sine wave signal is zero and also stopped at the point of time when the current of the sine wave signal is zero, and thus it is possible to reduce the noise generation and increase the life span of the electronic devices, thereby enhancing reliability and durability of the heat control device. Furthermore, the sine wave signal may be simultaneously supplied to two or more heat generating glasses or supplied with a time difference, considering a capacity of the power source part and an electric power amount supplied to an output stage. Therefore, the load of the power source may be increased to a certain extent, but the sine wave signal can be stably supplied to the heat generating glass within an allowed range of the power source part by measuring the electric power amount supplied to the output stage. Further, in the second embodiment, since the power source part should be designed to have a somewhat large capacity, a size and a manufacturing cost of the heat control device may be increased.

The heat control part 18 of FIG. 2 includes a communication part (e.g., RS-485) for receiving/transferring a signal from/to an external device, an input and operation part 15 which inputs or sets a temperature and operates the heat control device, and a display part 16 which is comprised of LCD or LED so as to display a numerical value input when setting the temperature or display setting temperature, present temperature and humidity. Indoor temperature and humidity are measured by a temperature and humidity sensor 17 which is disposed at one side and then input to the heat control part 17 in real time.

Further, in order to maintain the set temperature or prevent dew condensation on a surface of the heat generating glass, the heat control part 18 of FIG. 2 further includes a means in which the indoor temperature and humidity are measured by the temperature and humidity sensor 17 and the measured temperature and humidity are input to the heat control part in real time or periodically so as to find a temperature of the heat generating glass that the dew condensation does not occur and automatically maintain the temperature, and a dew condensation preventing means by which the temperature that the dew condensation does not occur is input as a setting temperature of the heat generating glass so as to prevent the dew condensation.

Furthermore, the heat control part 18 of FIG. 2 may be comprised of a one-chip microprocessor, or a microprocessor and a memory, and may be manufactured by mounting the above-mentioned technical construction for controlling the heating temperature in the control program.

As described above, the heat control device of the heat generating glass supplies the sine wave signal as the power to the heat generating glass, wherein the sine wave signal is input at a point of time when the current of the sine wave signal is zero, and also the supply of the sine wave signal is stopped at the point of time when the current of the sine wave signal is zero, so that a peak current is not generated at the sine wave signal. Thus, it is possible to reduce the noise generation and increase the life span of the electronic devices, thereby enhancing reliability and durability of the heat control device. In addition, the heat control part, the power source part and the driver circuits 19 to are interlocked with each other so that the sine wave signal is not supplied simultaneously to two or more heat generating glasses, thereby preventing the over-load of the power source part and thus increasing reliability and durability of the heat control device.

According to the present invention, the commercial alternating current power (sine wave signal) as power source used in controlling a heating temperature of a heat generating glass is supplied so that the power supply is started at a point of time when current of the sine signal is zero and also stopped at the point of time when the current of the sine signal is zero, thereby preventing generation of a peak current when the signal is supplied or stopped, and thus it is possible to reduce the noise generation and increase the life span of the electronic devices, thereby enhancing reliability and durability of the heat control device.

Further, the supply of the sine wave signal for uniformly or differently controlling electric energy and then supplying it to a plurality of heat generating glasses is started or stopped at the point of time when the current of the sine signal is zero, and the heating temperature of the heat generating glass can be controlled by changing the number of the sine wave signals to be supplied.

Further, the temperature of the heat generating glass and current supplied to each heat generating glass are measured to prevent occurrence of overheat or overcurrent, thereby enhancing stability and reliability thereof.

Further, the plurality of control signals and driver circuits are interlocked using the phase detection part and the heat control part so that the sine wave signal is not supplied simultaneously to two or more heat generating glasses, thereby preventing over-load in a power source part and thus damage of the power source part.

Further, the indoor temperature and humidity are measured to find the temperature that the dew condensation does not occur, and the temperature is automatically maintained, thereby preventing dew condensation on a surface of the heat generating glass.

While the present invention has been described with respect to the specific embodiments, it will be apparent to those skilled in the art that various changes and modifications may be made without departing from the spirit and scope of the invention as defined in the following claims.

1. A heat control device which controls heating temperature of a heat generating glass, comprising:
a phase detection part which detects a zero point of a sine wave signal;
a heat control part which generates a control signal for controlling supply of the sine wave signal using the zero point of the sine wave signal detected by the phase detection part, so that the sine wave is input to the heat generating glass at a point of time when current of the sine wave signal is zero and also the supplying of the sine wave signal is also stopped at the point of time when the current of the sine wave signal is zero; and
a driver circuit which supplies the sine wave signal to the heat generating glass at a point of time designated by the control signal using the control signal transferred from the heat control part and the sine wave signal input from a power source part.

2. The heat control device of claim 1, wherein the heat control part supplies the plurality of control signals to the plurality of driver circuits so as to control the heating temperature of the plurality of heat generating glasses.

3. The heat control device of claim 2, wherein the heat control part controls the sine wave signal so that the sine wave signal is input at a point of time when the current of the sine wave signal is zero, and also the supply of the sine wave signal is stopped at the point of time when the current of the sine wave signal is zero, and when the sine wave signal is supplied to the plurality of the heat generating glasses, the sine wave signal is not supplied simultaneously to two or more heat generating glasses, thereby preventing an increase of load in the power source part.

4. The heat control device of claim 1, wherein the heat control part comprises a temperature detection part for detecting temperature of each heat generating glass, and a current detection part for measuring current supplied to each heat generating glass, and also the heat control part stops the power supply when overheat or overcurrent is generated.

5. The heat control device of claim 1, wherein the phase detection part is comprised of a photocoupler.

6. The heat control device of claim 5, wherein the heat control part supplies the sine wave signal so as to measure indoor temperature and humidity using a temperature and humidity sensor, find a temperature of the heat generating glass that dew condensation does not occur, based on the measured temperature and humidity, and automatically maintain the temperature that the dew condensation does not occur, thereby preventing occurrence of the dew condensation.

7. The heat control device of claim 1, wherein the heat control part comprises an input and operation part which inputs a setting temperature of the heat generating glass and operates the heat control device, and further comprises a display part which displays the setting temperature and present temperature.

8. The heat control device of claim 1, wherein the heat control device further comprises a communication part for receiving/transferring a signal from/to an external device.

9. The heat control device of claim 2, wherein the heat control part comprises a temperature detection part for detecting temperature of each heat generating glass, and a current detection part for measuring current supplied to each heat generating glass, and also the heat control part stops the power supply when overheat or overcurrent is generated.

10. The heat control device of claim 3, wherein the heat control part comprises a temperature detection part for detecting temperature of each heat generating glass, and a current detection part for measuring current supplied to each heat generating glass, and also the heat control part stops the power supply when overheat or overcurrent is generated.

11. The heat control device of claim 2, wherein the phase detection part is comprised of a photocoupler.

12. The heat control device of claim 3, wherein the phase detection part is comprised of a photocoupler.

13. The heat control device of claim 11, wherein the heat control part supplies the sine wave signal so as to measure indoor temperature and humidity using a temperature and humidity sensor, find a temperature of the heat generating glass that dew condensation does not occur, based on the measured temperature and humidity, and automatically maintain the temperature that the dew condensation does not occur, thereby preventing occurrence of the dew condensation.

14. The heat control device of claim 12, wherein the heat control part supplies the sine wave signal so as to measure indoor temperature and humidity using a temperature and humidity sensor, find a temperature of the heat generating glass that dew condensation does not occur, based on the measured temperature and humidity, and automatically maintain the temperature that the dew condensation does not occur, thereby preventing occurrence of the dew condensation.

15. The heat control device of claim 2, wherein the heat control part comprises an input and operation part which inputs a setting temperature of the heat generating glass and operates the heat control device, and further comprises a display part which displays the setting temperature and present temperature.

16. The heat control device of claim 3, wherein the heat control part comprises an input and operation part which inputs a setting temperature of the heat generating glass and operates the heat control device, and further comprises a display part which displays the setting temperature and present temperature.

17. The heat control device of claim 2, wherein the heat control device further comprises a communication part for receiving/transferring a signal from/to an external device.

18. The heat control device of claim 3, wherein the heat control device further comprises a communication part for receiving/transferring a signal from/to an external device.
